(19) United States
(12) Patent Application Publication
(10) Pub. No.: US 2026/0307472 A1
(43) Pub. Date: Oct. 8, 2026

(54) THERMAL MODULE FOR A MOTOR VEHICLE

(71) Applicant: Valeo Electrification, Cergy Pontoise (FR)

(72) Inventors: Remi Tournois, Le Mesnil-Saint-Denis Cedex (FR); Sebastien Riviere, Bad Rodach (DE)

(73) Assignee: Valeo Electrification, Cergy Pontoise (FR)

(21) Appl. No.: 19/108,374

(22) PCT Filed: Aug. 23, 2023
(86) PCT No.: PCT/EP2023/073086

§ 371 Date: Mar. 3, 2025

(30) Foreign Application Priority Data
Sep. 1, 2022 (FR) FR2208790

(51) Int. Cl. B60K 11/04; B60H 1/00; B60K 11/08

(52) U.S. Cl. CPC B60K 11/04; B60K 11/08; B60H 1/00321

(57) ABSTRACT

A thermal module to be placed on the front face of a motor vehicle is disclosed herein. The thermal module includes a heat exchanger, a motor-fan unit, and a guiding device for guiding an air flow. The guiding device and the motor-fan unit overlap a peripheral edge and are attached to each other at a plurality of attachment zones. The guiding device and the motor-fan unit are in contact with each other. The contact between the guiding device and the motor-fan unit is configured to form at least one primary sealing zone including at least one baffle and at least one secondary sealing zone in which the guiding device and the motor-fan unit are in planar abutment.

The present invention relates to the field of motor vehicle thermal treatment systems and relates more specifically to a thermal module intended to be placed on the front face of a vehicle and to be traversed by an air flow.

Vehicles, and notably motor vehicles, are commonly fitted with a refrigerant fluid circuit and/or with a heat-transfer fluid circuit, which are used to contribute to a heat treatment of various zones or various components of the vehicle.

In order to thermally treat the passenger compartment of the vehicle and/or the components of the drive train of the vehicle, a heat exchange is carried out between the aforementioned fluids and an air flow outside the passenger compartment. To this end, the refrigerant fluid and the heat-transfer fluid are caused to pass through one or more heat exchangers fitted to the vehicle, notably on the front face of the vehicle, the air flow passing through a grille to pass through these heat exchangers.

Such heat exchangers are commonly arranged within thermal modules, between a guiding device, by which the air flow entering via the grille is guided through the heat exchanger, and a motorized fan unit, also known by the abbreviation “GMV”, which can for example be used, when the vehicle is stationary, to force the flow of outside air to circulate through the heat exchanger. The circulation of the air flow within the thermal module, both when the vehicle is traveling at a high speed, which means that a large volume of outside air is entering the guiding device, and when the motorized fan unit is operating at high speed, generates an overpressure within the thermal module with respect to the environment outside the thermal module.

Such an overpressure is liable to cause air leaks, i.e. air escaping from the thermal module, for example at the join between the guiding device and the heat exchangers, and therefore without passing through the heat exchanger or exchangers arranged within the thermal module. Such leaks thus have the effect of reducing the efficiency of the thermal module. It is known to limit leaks within the thermal module by placing one or more layers of rubber, such as EPDM, between the components of the thermal module. It is also known to limit leaks within the thermal module by having an assembled and/or overmolded part (for example made of EPDM) or by gluing or snap-fastening a foam component.

However, such a solution is not satisfactory because it significantly increases the cost of manufacturing a thermal module, notably by increasing the number of constituent elements of the thermal module.

The present invention falls within this context and proposes to overcome the drawbacks of the prior art, notably proposing a thermal module in which air leaks are limited without having to use a material specifically dedicated to this function and interposed between the guiding device, the heat exchangers and/or the motorized fan unit.

The invention thus relates to a thermal module intended to be placed on the front face of a motor vehicle, the thermal module comprising a heat exchanger, a motorized fan unit and a device for guiding an air flow, the heat exchanger being arranged between the guiding device and the motorized fan unit, the heat exchanger comprising an inner face arranged opposite the guiding device and an outer face opposite the motorized fan unit, the inner face and the outer face of the heat exchanger being joined to each other by a peripheral edge, characterized in that the guiding device and the motorized fan unit overlap the peripheral edge of the heat exchanger and are fastened to each another in a plurality of fastening zones each comprising at least one fastening means, the guiding device and the motorized fan unit being in contact with each other around the periphery of the peripheral edge of the heat exchanger outside the fastening zones so as to form a sealing device for the thermal module.

The motorized fan unit and the guiding device are directly secured to each other by the fastening means. In other words, the guiding device and the motorized fan unit are directly fastened to each other, via opposing portions of these components, without any additional material being interposed between the motorized fan unit and the guiding device to seal the thermal module. Thus, according to the invention, the contact between the guiding device and the motorized fan unit, configured to form a primary sealing zone and a secondary sealing zone, seals the thermal module without having to add sealing material such as elastomers or notably ethylene-propylene-diene monomer (EPDM).

According to one feature of the invention, the inner face of the heat exchanger is directly opposite the guiding device and the outer face of the heat exchanger is directly opposite the motorized fan unit. It will be understood that such a feature of the thermal module is advantageously obtained because the sealing zones obviate the need to use a sealing material specifically dedicated to sealing the thermal module.

According to one feature of the invention, the sealing device includes at least one primary sealing zone in which the cooperation of the guiding device and the motorized fan unit forms a chicane and at least one secondary sealing zone in which the cooperation of the guiding device and of the motorized fan unit consists of a flat support.

The chicane present in the primary sealing zone lengthens the path to be taken by the air flow to exit the thermal module, thereby greatly limiting the quantity of air liable to leak out of this primary sealing zone.

The secondary sealing zone comprises a flat support advantageously used, during assembly of the thermal module, to position the motorized fan unit with respect to the guiding device, taking into account manufacturing tolerances.

Each of the primary and secondary sealing zones extends along one side of the thermal module outside the fastening zones where the motorized fan unit and the guiding device are secured to each other by the fastening means.

Thus, a sealing zone is associated with a chicane, i.e. an effective zone for reducing leaks on account of the tortuous path that the air is forced to take to exit this zone, but which provides positioning clearance for one of the components forming the chicane with respect to the other, with a flat-contact primary sealing zone, which prevents air from passing between the components forming this primary sealing zone.

According to one feature of the invention, the chicane of the primary sealing zone is formed by a groove in which a rib is seated, the groove being formed on the motorized fan unit or the guiding device and the rib on the other. Such cooperation enables the chicane present in the primary sealing zone to be produced simply and efficiently.

According to one feature of the invention, at least a part of the peripheral edge of the heat exchanger is directly opposite the guiding device and/or the motorized fan unit. In other words, the thermal module does not require the use of a specific part (for example, an elastomer such as EPDM or foam), the function of which in the prior art is to limit air flow losses between the motorized fan unit and the guiding device, while absorbing the manufacturing and assembly tolerances of the thermal module. It will be understood that the guiding device and/or the motorized fan unit includes flanks intended to be near to, and if necessary in direct contact with, the peripheral edge of the heat exchanger, and that the fastening means and the fastening zones and the sealing zones overlap the peripheral edge of the heat exchanger.

According to one feature of the invention, the thermal module comprises at least one positioning means used to position the motorized fan unit and the guiding device with respect to each other. This positioning means makes it possible to easily adjust the position of the guiding device and the motorized fan unit with respect to each other during the assembly of the thermal module. Such an adjustment is notably used to quickly and simply achieve contact between the guiding device and the motorized fan unit, notably to form the sealing device.

According to one feature of the invention, the positioning means is formed by a positioning pin and an orifice, the positioning pin being formed on the guiding device or the motorized fan unit and intended to be seated in the orifice formed on the other. It is understood that the positioning pin is intended to be seated in the orifice, the latter having a diameter complementary to the positioning pin to allow the insertion thereof, such insertion adjusting the position of the guiding device with respect to the motorized fan unit, and therefore the contact between the two to form the sealing device.

According to one feature of the invention, the peripheral edge extends over at least three sides of the heat exchanger, and at least one fastening means is provided on each side of the heat exchanger. The distribution of the fastening means is substantially uniform along the sides of the thermal module. Such a distribution advantageously distributes the forces allowing the motorized fan unit and the guiding device to be integral with each other. It should be noted that this distribution of the fastening means makes it possible to limit air flow losses by constraining the motorized fan unit against the guiding device as much as possible.

According to one feature of the invention, the fastening means is formed by an elastically deformable tab formed on the motorized fan unit and/or on the guiding device and intended to cooperate with a seat provided in the guiding device and/or the motorized fan unit.

According to one feature of the invention, a secondary sealing zone is formed on a side of the peripheral edge of the heat exchanger opposite to a side of the peripheral edge of the heat exchanger comprising a primary sealing zone. In such a configuration, the chicane, and for example the rib contributing to forming such a chicane, extends mainly along the peripheral edge side in a first direction, and the flat support extends parallel to this first direction. In this way, the positioning of the two components, specifically the motorized fan unit and the guiding device, in contact with each other in the secondary sealing zone, can generate, depending on the adjustment due to manufacturing and assembly tolerances, a displacement of the rib within the groove in a direction perpendicular to the first direction. In other words, the secondary sealing zone can, if necessary, slightly deform the motorized fan unit and/or the guiding device in an adjustment direction perpendicular to the first direction, and the primary sealing zone has a clearance for fitting the rib in the groove, in this same direction of adjustment, notably so that the assembly of the thermal module can take manufacturing tolerances into account. In this context, the secondary sealing zone and the primary sealing zone are arranged on opposite sides, considering the adjustment direction.

According to a second object, the invention relates to a motor vehicle comprising a thermal module according to any one of the features set out above.

Other features, details and advantages of the invention will become more clearly apparent on reading the description below and on studying several exemplary embodiments given by way of non-limiting indication with reference to the appended schematic drawings, in which:

FIG. 1 is a schematic view of a thermal module according to the invention, intended to be arranged on the front face of a vehicle;

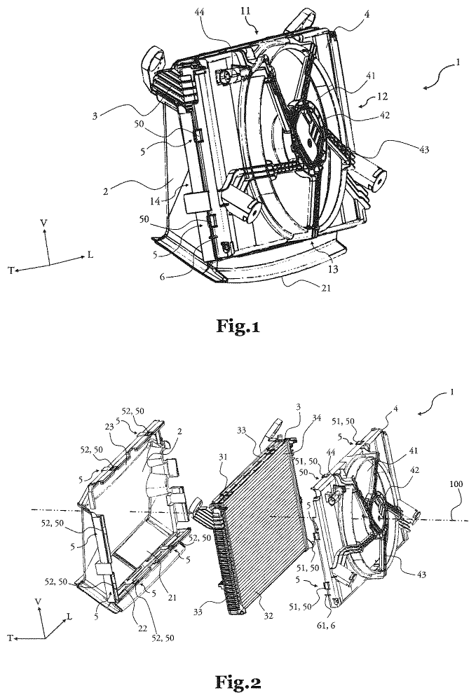

FIG. 2 is a schematic exploded view of the thermal module shown in FIG. 1;

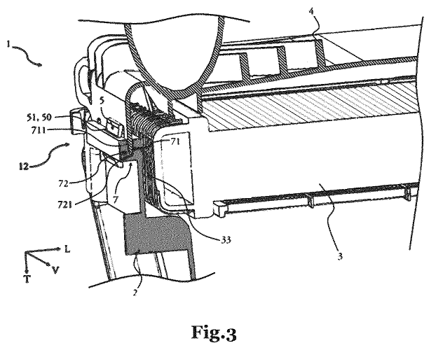

FIG. 3 is a schematic sectional view of one side of the thermal module where the contact between a motorized fan unit and a guiding device is configured to form a primary sealing zone;

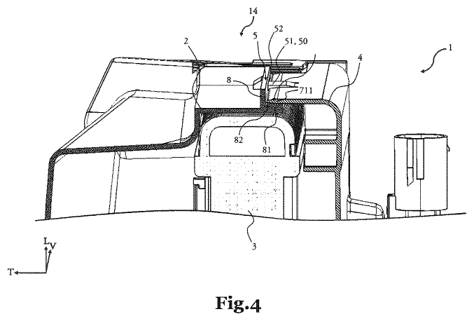

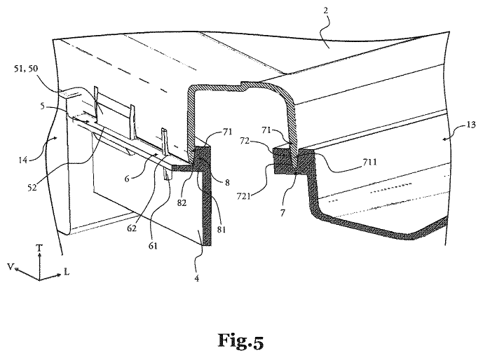

FIG. 4 is a schematic sectional view of another side of the thermal module where the contact between the motorized fan unit and the guiding device is configured to form a secondary sealing zone;

FIG. 5 is a schematic sectional view through a primary sealing zone on one side of the thermal module and a secondary sealing zone on another side of the thermal module.

It should first be noted that while the figures show the invention in detail to enable the invention to be carried out, these figures may of course be used to better define the invention where appropriate. It also should be noted that these figures merely disclose example embodiments of the invention.

The features, variants and different embodiments of the invention may be combined with one another, in various combinations, provided that they are not mutually incompatible or exclusive. Notably, it is possible to envisage variants of the invention that comprise only a selection of features described below, independently of the other features described, if this selection of features is sufficient to confer a technical advantage or to differentiate the invention from the prior art.

In the figures, elements common to several figures have the same reference sign.

In the detailed description below, the terms “longitudinal”, “transverse” and “vertical” refer to the orientation of the thermal module within a trihedron L, V, T, as arbitrarily defined. A transverse direction corresponds to the stacking direction of the thermal module, this transverse direction being parallel to a transverse axis T of a coordinate system L, V, T illustrated in the figures. A vertical direction corresponds to a direction parallel to a vertical axis V of the coordinate system L, V, T, this vertical axis V being perpendicular to the transverse axis T. Finally, a longitudinal direction corresponds to a direction parallel to a longitudinal axis L of the coordinate system L, V, T, this longitudinal axis L being perpendicular to the transverse axis T and to the vertical axis V.

FIG. 1 illustrates a thermal module 1 according to an embodiment of the present invention. This thermal module 1 is intended to be fitted to a vehicle, notably a motor vehicle, in order to effect a heat exchange with an air flow passing therethrough. To this end, the thermal module 1 comprises at least one device 2 for guiding the air flow, a heat exchanger 3 intended to effect a heat exchange with the air flow, and a motorized fan unit 4. The thermal module 1 extends mainly in a vertical and longitudinal plane, parallel to the vertical axis V and the longitudinal axis L. Like the thermal module 1, the guiding device 2, the heat exchanger 3 and the motorized fan unit 4 extend mainly in a vertical and longitudinal plane.

When the thermal module 1 is assembled, the guiding device 2 contributes to delimiting a duct for guiding the air flow, from an inlet opening 21, through which the air flow can enter the thermal module 1, to the heat exchanger 3.

The thermal module 1 is arranged on the front face of the motor vehicle, and more precisely at an opening made in the bodywork of said vehicle, also called a grille, the flow of air coming from outside the vehicle being able to enter the thermal module 1 through this grille. To this end, the inlet of the guiding device 2 of the thermal module 1, and more precisely the inlet opening 21 of the guiding device 2, is arranged at this grille so that the air flow can enter the thermal module 1, directly or indirectly. It will be understood that the inlet opening 21 can be placed directly in contact with the grille or be indirectly connected to the grille, for example by means of a duct joining the grille to the inlet opening 21.

The motorized fan unit 4 is arranged opposite the guiding device 2, with the heat exchanger 3 interposed between these two components. The motorized fan unit 4 and the guiding device come into contact with each other around the heat exchanger 3, forming different contact zones, including a first side 11, a second side 12, a third side 13 and a fourth side 14, each of these sides 11, 12, 13 and 14 forming the periphery of the thermal module 1.

Where reference is made below to cooperation between the motorized fan unit 4 and the guiding device 2, it will be understood that this relates to a housing of the motorized fan unit, which has an outlet opening 41 through which the air flow is able to exit the thermal module 1. The motorized fan unit 4 also comprises a means for circulating the air flow 42, formed by an impeller comprising a plurality of blades 43, and held in position in the housing of the motorized fan unit. This means for circulating the air flow 42 is capable of forcing the air flow to circulate within the thermal module, notably in a direction of circulation going from the inlet opening 21 to the outlet opening 41. This means for circulating the air flow 42 is, in the embodiment shown, electrically powered by an electrical power supply cable 44.

The air flow entering via the inlet opening 21 then passes through the heat exchanger 3, where a heat exchange is effected between the air flow and a heat-transfer fluid passing through the heat exchanger 3, before exiting the thermal module 1 via the outlet opening 41. It will be understood that the heat exchanger 3 is arranged within the thermal module 1 between the guiding device 2 and the motorized fan unit 4 in such a way that it lies across the air flow.

The guiding device 2 and the motorized fan unit 4 are fastened to each another in a plurality of fastening zones 5 each comprising at least one fastening means 50. These fastening means 50 are used to secure the motorized fan unit 4 and the guiding device 2 directly to each other, enclosing the heat exchanger therebetween. Securing the motorized fan unit 4 to the guiding device 2 in this manner enables the guiding device 2, the heat exchanger 3 and the motorized fan unit 4 to form a one-piece assembly within which the air flow is forced to circulate from one opening 21, 41 to the other.

Furthermore, the thermal module 1 comprises positioning means 6 used to position the guiding device 2 and the motorized fan unit 4 with respect to each other during assembly thereof.

FIG. 2 is an exploded view of the thermal module 1 according to the embodiment shown in FIG. 1. More precisely, and as shown in FIG. 2, the guiding device 2, the heat exchanger 3 and the motorized fan unit 4 are assembled with respect to each another along a stacking axis 100 substantially parallel to the axis T.

Furthermore, the guiding device 2 comprises a support 22 intended to receive the heat exchanger 3. More precisely, the heat exchanger 3 is arranged on the support 22 of the guiding device 2 in such a way that an inner face 31 of the heat exchanger 3 bears against the guiding device, in this case bearing against a stop 23 formed by a wall of the guiding device opposite the support 22. It will be understood that an outer face 32 of the heat exchanger 3, opposite to the inner face 31, is then intended to face the motorized fan unit 4.

The heat exchanger 3 comprises an exchange surface 34 configured so that it can be traversed by the flow of outside air circulating within the thermal module from the air inlet opening 21 to the air outlet opening 41. This exchange surface here comprises a plurality of tubes within which a heat-transfer fluid circulates and the air flow passing through this exchange surface between the tubes is capable of yielding or recovering heat to/from this heat-transfer fluid via the tubes.

The inner and outer faces 31, 32 of the heat exchanger 3 are joined to each other by a peripheral edge 33. It should be noted that this peripheral edge 33 extends in a direction parallel to the stacking axis 100 when the thermal module 1 is assembled.

The guiding device 2 and the motorized fan unit 4 are configured to overlap the peripheral edge 33 of the heat exchanger 3 when the thermal module 1 is assembled. More specifically, the guiding device and the motorized fan unit each have flanks arranged at the periphery which extend the guiding device and the motorized fan unit substantially along the stacking axis 100, and these flanks are arranged to overlap the peripheral edge 33 of the heat exchanger 3.

This overlapping of the peripheral edge 33 is such that at least a part of the peripheral edge 33 is directly opposite the guiding device 2 and/or the motorized fan unit 4. It will be understood that the overlapping of the peripheral edge 33 by the guiding device 2 and the motorized fan unit 4 ensures sufficient sealing of the thermal module 1, thereby obviating the need for a material dedicated to this function interposed between the guiding device 2 and the motorized fan unit 4.

The guiding device 2 and the motorized fan unit 4 are fastened to each other by fastening means 50. These fastening means are here carried by the flanks of the guiding device and of the motorized fan unit which overlap the peripheral edge.

As shown in FIG. 2, each of the fastening means 50 is formed by the cooperation between an elastically deformable tab 51 and a seat 52. The tab 51 is formed on the guiding device 2 and/or the motorized fan unit 4, and more specifically on one of the flanks of the guiding device 2 and/or of the motorized fan unit 4, and the seat 52 on the other, and more specifically on one of the corresponding flanks. In the embodiment shown in FIG. 2, the tab 51 is formed on a flank of the motorized fan unit 4 and the seat 52 is formed on a flank of the guiding device 2.

The tab 51 extends in a direction substantially parallel to the transverse axis T, i.e. substantially parallel to the stacking axis 100, from a portion of the motorized fan unit 4 overlapping the peripheral edge 33 when the thermal module 1 is assembled, i.e. from one of the flanks of the motorized fan unit. This tab 51 is intended to be seated in the associated seat 52 formed on a portion of the guiding device 2 overlapping the peripheral edge 33, i.e. on one of the flanks of the guiding device. To this end, the tab 51 has a chamfer at one free end to facilitate insertion of the tab 51 into the seat 52 with an elastic deformation of the tab 51, and a shoulder to hold the tab 51 in the seat 52 following elastic return of the tab 51 to the initial position thereof. A snap-fastening deformation by elastic deformation is thus produced, which is particularly simple to implement.

Such cooperation between the tab 51 and the seat 52 keeps the guiding device 2 integral with the motorized fan unit 4, the heat exchanger 3 being constrained between the guiding device 2 and the motorized fan unit 4.

In the embodiment shown, the thermal module 1 comprises eight fastening zones 5 uniformly distributed along the entire peripheral edge 33, each of these fastening zones 5 comprising a fastening means 50. It should be noted that this is an example embodiment that does not limit the number of fastening zones 5, and also that other fastening means could be used without departing from the scope of the invention.

It should be noted that the insertion of the tab 51 into the associated seat 52 is advantageously adjusted by the positioning means 6. In other words, the positioning means 6 is used to position the guiding device 2 and the motorized fan unit 4 with respect to each other. This positioning means 6 is formed by the cooperation between a positioning pin 61, extending in a direction substantially parallel to the transverse axis T and to the stacking axis 100 and arranged on the motorized fan unit 4, and an orifice 62 formed in the guiding device 2, the positioning pin 61 being intended to be seated in the orifice 62. It should be noted that the positioning pin 61 may alternatively be provided on the guiding device 2 and the orifice 62 in the motorized fan unit 4, provided that the positioning pin 61 is intended to be seated in the orifice 62.

It should also be noted that the peripheral edge 33 extends, according to one feature of the invention, over at least three sides. In the embodiment shown, this peripheral edge 33 extends over each of the first, second, third and fourth sides 11, 12, 13 and 14 of the thermal module. Each of the sides 11, 12, 13 and 14 comprises at least one fastening means 50, as well as a sealing zone contributing to forming the sealing device.

FIG. 3 is a very schematic sectional view of the second side 12 of the thermal module 1 shown in FIG. 1. On this second side 12, the guiding device 2 and the motorized fan unit 4 are in contact with each other, being arranged mainly on both sides of the heat exchanger 3, and they form a primary sealing zone 7 facing the peripheral edge 33 of the heat exchanger 3.

The primary sealing zone 7, created by the cooperation between the motorized fan unit 4 and the guiding device 2, forms a chicane 72, here formed by inserting a rib in a groove. More precisely, the guiding device 2 has a groove 721 in the portion overlapping the peripheral edge 33 on the second side 12. This groove 721 is intended to receive a lateral end 71 of the motorized fan unit 4 forming a groove 711 and overlapping the peripheral edge 33. When the groove 711 of the lateral end 71 of the motorized fan unit 4 is seated in the groove 721, the chicane 72 thus formed complicates the passage of air from inside the thermal module to outside the thermal module so as to limit air flow losses as a result of leakage between the guiding device 2 and the motorized fan unit 4. In other words, the chicane 72 disturbs the air flow caused to leak out of the thermal module 1 between the guiding device 2 and the motorized fan unit 4, so that the pressurized air flow continues to flow through the heat exchanger 3 rather than leaking out through the sides. Thus, the chicane 72 advantageously contributes to limiting the overall leakage rate of the air flow through the join of the guiding device 2 and the motorized fan unit 4 to a rate value not exceeding 3%.

The primary sealing zone 7 extends along one and the same side of the thermal module 1 outside the fastening zones 5.

FIG. 4 is a very schematic sectional view of the fourth side 14 of the thermal module 1. On this fourth side 14, the guiding device 2 and the motorized fan unit 4 are in contact with each other so as to form a secondary sealing zone 8.

Like the primary sealing zone 7, the secondary sealing zone 8 is formed by the cooperation between the motorized fan unit 4 and the guiding device 2.

More precisely, this secondary sealing zone 8 is formed, on this fourth side 14 of the thermal module 1, by the cooperation between, on the one hand, an L-shaped portion 81 and the rib 711 of the lateral end 71.

The secondary sealing zone 8 comprises a flat support 82 formed by positioning the rib 711 against the L-shaped portion 81. More precisely, the rib 711 is pressed against the L-shaped portion 81 so that this contact between the rib 711 and the L-shaped portion 81 creates a seal.

Furthermore, this secondary sealing zone 8 and more specifically the flat support 82 is used, when assembling the motorized fan unit 4 and the guiding device 2 with each other, to substantially deform the housing of the motorized fan unit 4 and to adjust the position of each of the ribs 711 arranged on the periphery of this motorized fan unit 4, and notably of the rib intended to be seated in the groove 721 to form the first primary sealing zone 7.

To this end, a wall of the L-shaped portion 81, and more specifically the wall against which the rib 711 is intended to rest, may have an incline forming an insertion ramp for the rib 711 along this L-shaped portion 81. The shape illustrated in FIG. 4, for a rib having a main elongation dimension in a first direction, in this case vertical, enables deformation in a second perpendicular direction, in this case longitudinal. The rib 711 intended to be seated in the groove 721 to form the first primary sealing zone 7 can be offset in this second direction, in this case longitudinal. It is thus advantageous, as mentioned, for the primary sealing zone to be arranged opposite a secondary sealing zone, so that the position of the rib 711 can be adjusted within the width of the groove, also in the second direction, in this case the longitudinal direction.

It will be understood that the flat support 82 formed between the rib 711 and the L-shaped portion 81, i.e. between the motorized fan unit 4 and the guiding device 2, allows the motorized fan unit 4 and the guiding device 2 to be positioned with a certain degree of freedom with respect to each other while ensuring the sealing of the thermal module 1.

FIG. 5 more specifically illustrates the distinction between primary and secondary sealing zones 7 and 8 along the peripheral edge 33 of the thermal module 1. More precisely, FIG. 5 is a schematic sectional view passing through a primary sealing zone 7 on the third side 13 and through a secondary sealing zone 8 on the fourth side 14.

First of all, it should be specified that, for the sake of simplifying the understanding of FIG. 5, the heat exchanger 3 has been removed from the assembly of the thermal module 1. Of course, the dimensions as well as the proportions of the various elements present in this FIG. 5 take account of an embodiment comprising the heat exchanger 3.

FIG. 5 is intended to show the structural difference between a primary sealing zone 7 including a chicane 72 and a secondary sealing zone 8 comprising a flat support 82, by illustrating two successive sides 13, 14 of the thermal module. As mentioned above, the primary and secondary sealing zones 7 and 8 of the thermal module 1 are distributed such that a secondary sealing zone 8 is formed on a side of the thermal module 1 opposite to a side of the thermal module 1 comprising a primary sealing zone 7. In this context, two adjacent sides can be provided with a primary sealing zone with a chicane, or just one side can be provided with a primary sealing zone.

More precisely, the distribution of the primary and secondary sealing zones 7 and 8 is such that the stresses associated with the insertion of the rib 711 into the groove 721 to form the sealing zone are absorbed by the flat support 82 of the secondary sealing zone 8, notably made possible at the time of assembly by the inclined plane formed by one of the walls of the L-shaped portion 81, as mentioned above.

The invention as described above achieves the stated aims by proposing a thermal module in which sealing is ensured by direct contact between the motorized fan unit and the guiding device. Variants not described here could be implemented without departing from the scope of the invention, provided that, according to the invention, they comprise a thermal module in which direct contact between the guiding device and the motorized fan unit enables a seal to be created without any additional parts, notably forming a primary sealing zone with a chicane and a secondary sealing zone comprising at least one flat support.

1. A thermal module to be placed on a front face of a motor vehicle, the thermal module comprising:
a heat exchanger;
a motorized fan unit; and
a device for guiding an air flow,
wherein the heat exchanger being arranged between the guiding device and the motorized fan unit,
wherein the heat exchanger comprising an inner face arranged opposite the guiding device and an outer face opposite the motorized fan unit,
wherein the inner face and the outer face of the heat exchanger being joined to each other by a peripheral edge,
wherein the guiding device and the motorized fan unit overlap the peripheral edge of the heat exchanger and are fastened to each another in a plurality of fastening zones each comprising at least one fastening means,
wherein the guiding device and the motorized fan unit is in contact with each other around a periphery of the peripheral edge outside the fastening zones so as to form a sealing device for the thermal module.

2. The thermal module as claimed in claim 1 wherein the sealing device comprises:
at least one primary sealing zone in which a cooperation of the guiding device and the motorized fan unit forms a chicane; and
at least one secondary sealing zone in which the cooperation of the guiding device and of the motorized fan unit consists of a flat support.

3. The thermal module as claimed in claim 2,
wherein the chicane of the primary sealing zone is formed by a groove in which a rib is seated,
wherein the groove is formed on the motorized fan unit or the guiding device and the rib on the other.

4. The thermal module claimed in claim 1 wherein at least a part of the peripheral edge of the heat exchanger is directly opposite the guiding device and/or the motorized fan unit.

5. The thermal module as claimed in claim 1 further comprising at least one positioning means used to position the motorized fan unit and the guiding device with respect to each other.

6. The thermal module as claimed in claim 5
wherein the positioning means is formed by a positioning pin and an orifice,
wherein the positioning pin is formed on the guiding device or the motorized fan unit and intended is to be seated in the orifice formed on the other.

7. The thermal module as claimed in claim 1,
wherein the peripheral edge extends over at least three sides of the heat exchanger,
wherein at least one fastening means is provided on each side of the heat exchanger.

8. The thermal module as claimed in claim 7 wherein the fastening means is formed by an elastically deformable tab formed on the motorized fan unit and/or on the guiding device to cooperate with a seat provided in the guiding device and/or the motorized fan unit.

9. The thermal module as claimed in claim 1, wherein a secondary sealing zone is formed on a side of the peripheral edge of the heat exchanger opposite to a side of the peripheral edge of the heat exchanger comprising a primary sealing zone.

10. A motor vehicle comprising the thermal module to be placed on the front face of the vehicle as claimed in claim 1.
